(19) United States
(12) Patent Application Publication
(10) Pub. No.: US 2010/0079391 A1
(43) Pub. Date: Apr. 1, 2010

(54) TOUCH PANEL APPARATUS USING TACTILE SENSOR

(75) Inventor: Il-Kweon JOUNG, Seongnam-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/428,242

(22) Filed: Apr. 22, 2009

(30) Foreign Application Priority Data
Sep. 30, 2008 (KR) 10-2008-0096251

(51) Int. Cl. G06F 3/041

(52) U.S. Cl. 345/173

(57) ABSTRACT

In accordance with an embodiment of the present invention, the touch panel apparatus can include a panel; a plurality of tactile sensors, disposed at each corner of a lower surface of the panel; and a position calculator, configured to calculate a two-dimensional coordinate corresponding to a contact position on the basis of a ratio of sensed values of a contact, outputted from the tactile sensors, if the contact is made on a surface of the panel.

### CROSS-REFERENCE TO RELATED APPLICATIONS

This application claims the benefit of Korean Patent Application No. 10-2008-0096251 filed with the Korean Intellectual Property Office on Sep. 30, 2008, the disclosure of which is incorporated herein by reference in its entirety.

### BACKGROUND

1. Technical Field

The present invention relates to a tactile sensing technology, more specifically to a touch panel apparatus using a tactile sensor.

2. Description of the Related Art

The touch screen has been currently applied to portable apparatuses and various display apparatuses. Especially, the touch screen is applied to the mobile phones. Mobile phones including the touch screen are spreading rapidly. By this time, all developed media have mainly focused on the visual and auditory senses. It is expected, however, that the current trend will be changed. In the future, there will be the development of media related to the tactile and olfactory senses, not depending on the visual and auditory sense only.

Accordingly, the future gives salience to the tactile interface technology between humans and electronic apparatuses. If the technology related to an input device of the tactile interface technology is developed, this will increase the convenience of using the electronic apparatus and promote the development of new user interfaces and new concept products.

As a conventional touch panel apparatus, a five-wire resistive touch panel has been disclosed in International Publication No. WO02/069124.

In the conventional resistive film type touch panel, the light transmissivity of the touch panel is reduced. This has a significant disadvantageous effect on the performance of a touch screen apparatus.

The conventional touch panel apparatus needs complex electric line structure as well as a complex configuration of elements in order to sense a contact. Moreover, a resistive film is required to be formed on the whole active area, which is to be used for sensing a contact, in the touch panel. Accordingly, there has been a limitation in reducing the manufacturing cost of the touch panel apparatus.

Thus, there has been a demand for a new touch panel apparatus that can have no loss of the light transmissivity, use no resistive film, and be manufactured by using simpler structure and method.

### SUMMARY

Accordingly, the present invention provides a touch panel apparatus that can reduce the overall size of the touch panel apparatus, simplify the electric line structure, and reduce the manufacturing cost, by using a simple structure only, in which a tactile sensor is disposed at a corner on a lower surface of a typical flat panel.

An aspect of present invention features a touch panel apparatus, including a panel; a plurality of tactile sensors, disposed at each corner of a lower surface of the panel; and a position calculator, configured to calculate a two-dimensional coordinate corresponding to a contact position on the basis of a ratio of sensed values of a contact, outputted from the tactile sensors, if the contact is made on a surface of the panel.

Here, the panel can be a display panel for displaying a video corresponding to an inputted video signal.

The panel can have a rectangular shape, and each of the tactile sensors is disposed at each corner of a lower surface of the panel.

The position calculator can calculate the coordinate corresponding to the contact position by converting the ratio of the sensed values to a geometric distance-proportional relationship on a two-dimensional coordinate.

The touch panel apparatus can further include a table storage, configured to store a lookup table in which two-dimensional coordinates of the contact position are pre-determined according to ratios of the sensed values.

In this case, if the sensed values outputted from each of the tactile sensors are inputted, the position calculator can calculate the coordinate corresponding to the contact position by computing the ratio of the inputted sensed values and extracting data mapped to the computed ratio from the lookup table.

The touch panel apparatus can further include a magnitude calculator, configured to calculate a magnitude of a contact force generated at the contact position by comparing the sensed values with sensed values corresponding to a pre-standardized unit contact force.

The touch panel apparatus can further include a direction calculator, configured to calculate a moving direction of the contact position on the basis of a continuous coordinate change, if a two-dimensional coordinate calculated by the position calculator is continuously changed while a contact is maintained on the surface of the panel.

Here, the tactile sensor can be a 3-axis force sensor which individually outputs sensed values in the x-, y-, and z-axis directions when a contact is made on the surface of the panel.

The tactile sensor can also be a pressure sensor which outputs a pressure-sensed value related to a pressure that is perpendicular to the surface of the panel on which the contact is made.

### BRIEF DESCRIPTION OF THE DRAWINGS

FIG. 1 shows how a panel and a tactile sensor are disposed in a touch panel apparatus in accordance with an embodiment of the present invention;

FIG. 2 shows how the panel and the tactile sensor, which are shown in FIG. 1, are disposed in a touch panel apparatus when viewed at an angle that is different from that of FIG. 1;

FIG. 3 shows how the panel and the tactile sensor, which are shown in FIG. 1, are disposed in a touch panel apparatus when viewed from below;

FIG. 4 is a block diagram showing a brief structure of a touch panel apparatus in accordance with an embodiment of the present invention;

FIG. 5A shows how the contact position is calculated when a contact is made right at the center of a panel; and

FIG. 5B shows how the contact position is calculated when a contact is made at a position of a panel.

### DETAIL DESCRIPTION

Hereinafter, a touch panel apparatus using a tactile sensor in accordance with an embodiment of the present invention will be described with reference to the accompanying drawings. Throughout the description of the present invention, when describing a certain technology is determined to evade the point of the present invention, the pertinent detailed description will be omitted. Terms such as “first” and “second” can be used in describing various elements, but the above elements shall not be restricted to the above terms. The above terms are used only to distinguish one element from the other.

For the convenience of description, a touch screen apparatus will be described below as an example for various types of touch panel apparatuses. This is because the application field that mainly uses the tactile recognizing technology is a mere touch screen apparatus being used for various electronic devices such as mobile phones, PDAs, PMPs, laptop computers, UMPCs, automated teller machines, and fax/scanner/printers. The tactile recognizing technology, however, is applicable to many other fields. Accordingly, an embodiment of the present invention shall by no means restrict the scope of claims of the present invention.

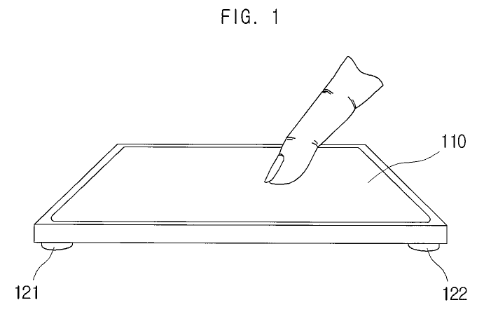

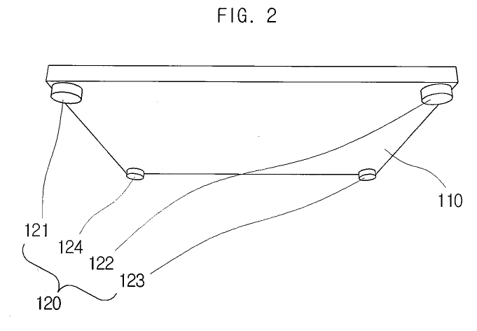

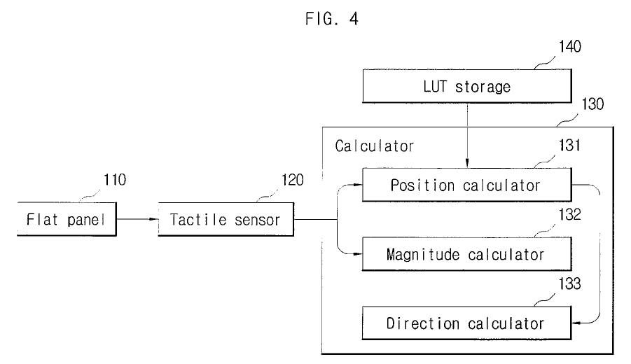

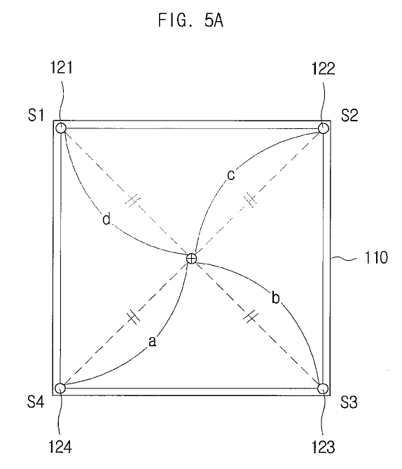

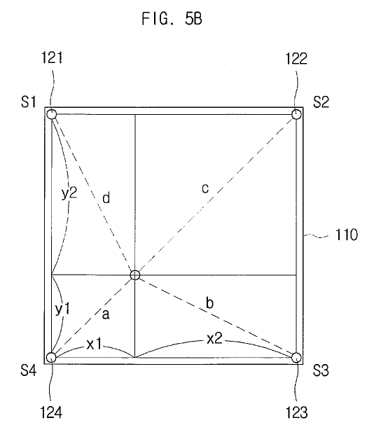

Hereinafter, the touch panel apparatus in accordance with an embodiment of the present invention will be described in detail by using the block diagram shown in FIG. 4 with reference to FIG. 1 through FIG. 3, FIG. 5A and FIG. 5B.

As shown in FIG. 4, the touch panel apparatus in accordance with an embodiment of the present invention can include a flat panel 110, a tactile sensor 120, a calculator 130, and an LUT storage 140. Here, the calculator 130 can include a position calculator 131, a magnitude calculator 132, and a direction calculator 133 according to the design specification related to the functions of the touch panel apparatus.

For example, in case that an embodiment of the present invention uses the touch screen apparatus as the touch panel apparatus, the flat-panel 110 can be a typical flat display panel such as LCD, PDP, and OLED, which display an two-dimensional video corresponding to an inputted video signal. Of course, it shall be obvious that a variety of flat panels can be used instead of the display panels.

Typically, the commonly used portable apparatus or fax/scanner/printer, which has a touch screen function, has used a touch panel manufactured as one body in the form in which a resistive film made of a transparent material is inserted between an upper plate and a lower plate of the panel. An embodiment of the present invention does not aim to use a touch panel manufactured as one body in the form that the panel itself can sense a contact position. In accordance with an embodiment of the present invention, it is possible to allow the typical flat-panel 110 to function as a touch panel or a touch screen by disposing one or more tactile sensors 120 at positions on the lower surface of the panel.

FIG. 1 through FIG. 3 show how the tactile sensors 120 are coupled and disposed on the flat panel 110.

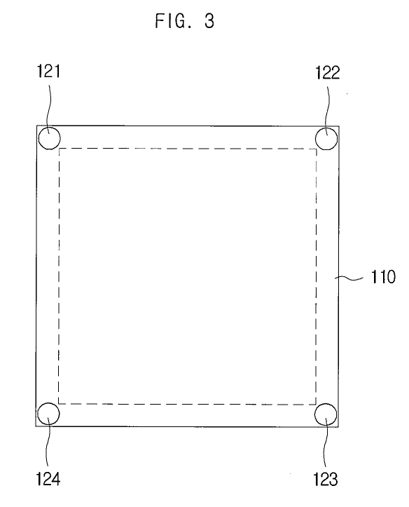

Especially, FIG. 3 shows the lower surface of the flat panel 110. Since the commonly-used flat panel 110 typically has a rectangular shape, the flat panel 110 shown in FIG. 1 through FIG. 3 has also a rectangular shape. The shape of the flat panel 110, however, can obviously follow the shape of an apparatus in which the flat panel is to be placed.

As shown in FIG. 1 through FIG. 3, the tactile sensor 120 can be disposed at each corner on the lower surface of the flat panel 110. For the convenience of description, the tactile sensor 120 disposed at an upper left corner can be named a first sensor 121. The remaining tactile sensors 120 can be a second sensor 122, a third sensor 123, and a fourth sensor, in the clockwise direction from the first sensor 121.

At this time, it is assumed that the tactile sensor 120 is disposed at each corner of the flat panel 110. The disposed position and the number of the tactile sensor 120 are not limited to this embodiment of the present invention. This is because the tactile sensor 120 can be disposed at a corner or a position of any side (refers to a dotted line area in FIG. 3) on the lower surface of the flat panel 110, according to the sensing principle of a contact position, a magnitude of a contact force, and a contact direction in accordance with an embodiment of the present invention. Alternatively, if it is assumed that the whole area of the lower surface of the flat panel 110 is divided into a plurality of sections and the tactile sensor 120 is disposed at each of the sections one by one, more tactile sensors 120 can be mounted.

In this embodiment of the present invention, only 4 sensors are assumed to be disposed at each corner in consideration of the simple configuration and reducing of the manufacturing cost, since it is enough that a fewer sensors can precisely sense a contact position, a magnitude of a contact force, and a contact direction.

In this embodiment of the present invention, any products or sensing devices performing various types of sensing methods can be employed as the tactile sensors 120. For example, in the case of using 3-axis force sensors as the tactile sensors 120, it is possible to individually sense the values in the x-, y-, and z-axis directions when a contact is made on a contact object. Accordingly, the magnitudes of contact forces which are transferred in each axis direction as well as contact positions can be checked together.

Alternatively, it is possible to use pressure sensors which output a sensed value related to the pressure that is perpendicular to the surface on which the contact is made, in consideration of the price of the tactile sensor 120 and the complexity of the sensing circuits. In accordance with an embodiment of the present invention, the touch panel apparatus can have the structure (refers to the calculator 130 in FIG. 4), in which the pressure sensors can sense all of a contact position, a magnitude of a contact force, and a contact direction. Accordingly, it is assumed that simple pressure sensors are used as the tactile sensors 120 in the below description.

As shown in the block diagram of FIG. 4, in accordance with an embodiment of the present invention, the calculator 130 in the touch panel apparatus can include the position calculator 131, the magnitude calculator 132, and the direction calculator 133, which are configured to precisely sense a contact position, a magnitude of a contact force, and a contact direction when the contact is made on a surface of the flat panel 110.

When a contact is made at a position on a surface of the flat panel 110, the position calculator 131 in accordance with an embodiment of the present invention can calculate a two-dimensional coordinate corresponding to the position, at which the contact is made, according to the ratio of sensed values outputted from each of the tactile sensors 121, 122, 123 and 124 placed on the lower surface of the flat panel 110.

The magnitude calculator 132 can calculate a magnitude of a contact force generated at the position by comparing the sensed values (not their ratio) outputted from each of the tactile sensors 121, 122, 123 and 124 with predetermined reference values.

For example, when an end of a human figure touches the touch screen apparatus, the magnitude of the touching force can be averaged. If it is assumed that the values, sensed by the sensors when the touch screen apparatus is touched, are pre-determined as reference values on the basis of the averaged magnitude (or other references are possible), it is possible to check how greatly the currently generated touching force is working by comparing the magnitude of the currently generated touching force with the averaged magnitude. Accordingly, the magnitude calculator 132 in accordance with an embodiment of the present invention can calculate the magnitude of the touching force at each touched position by using the above principle.

In addition, when a contact is maintained on the surface of the flat panel 110, if a two-dimensional coordinate corresponding to the contact position, calculated by the position calculator 131, is continuously changed, the direction calculator 133 in accordance with an embodiment of the present invention can calculate a changed direction of the contact position on the basis of the direction of the change of the coordinate.

The sensing of directions can be variously applied to the commonly used touch screen apparatus. For example, when a user drags or pushes a point on the surface of the touch screen in one direction of the upper and lower and right and left of the contact position, a screen picture displayed on a screen can be scrolled or dragged in the selected direction.

In accordance with an embodiment of the present invention, the above sensing of directions can be performed after the precise sensing of positions. Described below is how the position calculator 131 calculates a contact position.

When there is no contact is pressured on a surface of the flat panel 110, no sensed value can be measured by the first, second, third, and fourth sensors 121, 122, 123, and 124. Then, when a contact is pressured on the surface of the flat panel 110, each sensed value can be outputted by measuring a contact pressure by the first, second, third, and fourth sensors 121, 122, 123, and 124. Of course, circuits for obtaining sensing signals outputted from the sensors can be adequately designed according to the types of the employed sensors and the sensing methods.

For example, if it is assumed that a contact is pressured right in the center of the flat panel 110, the contact pressure generated in the center is scattered and transferred at the same ratio to each of the sensors, which are separated from the contact position by the same distance. In this case, pressure-sensed values, which are outputted from the first, second, third, and fourth sensors 121, 122, 123, and 124, are the same, and the ratio of each of the sensed value calculated by the position calculator 131 is 1:1:1:1.

Of course, when a user touches the surface of the flat panel 110 by using an end of his or her finger, even if the contact is touched in the center, the actually contact position may not be precisely the right center. Accordingly, the sensed values outputted from each of the sensors may not be completely identical to each other. When the position calculator 131 calculates the ratio of the sensed values, however, it is enough as long as such an error is in a predetermined acceptable error range in which a value having the error can be considered as the same sensed value. Thus, the error can be disregard in the specification.

In FIG. 5B, it is assumed that a contact is made at a position on the flat panel 110, not right in the center. In this case, the sensed values to be outputted from each of the sensor 121, 122, 123, and 124 may not be equal to each other.

In particular, the ratio of the sensed values may be identical to the ratio of the distances d, c, b, and a between the contact position and the positions at which each of the sensors 121, 122, 123, and 124 are disposed. Accordingly, it can be determined that the x-coordinate of the contact position is a point that divides the line between S4 and S3 at the ratio of x1:x2 (i.e. a:b) and the y-coordinate of the contact position is a point that divides the line between S4 and S1 at the ratio of y1:y2 (i.e. a:d)

The position calculator 311 can use the above principle to calculate the two-dimensional coordinate of the contact position. That is, the position calculator 311 can calculate the two-dimensional coordinate corresponding to the contact position by converting the ratio of each sensed value outputted from the sensors to a geometric distance-proportional relationship on the two-dimensional coordinate.

However, it may not be necessary to perform the converting process to the above geometric distance-proportional relationship in order that the position calculator 311 can calculate the two-dimensional coordinate of the contact position.

For example, the above converting process can be replaced with a lookup table in which the two-dimensional coordinate corresponding to the contact position is pre-mapped according to the ratios of the sensed values. In this case, the position calculator 131 can compute the ratios of the inputted sensed values and then extract data mapped to the computed ratios from the lookup table in order to calculate the two-dimensional coordinate corresponding to the contact position. In FIG. 4, the LUT storage 140 is further shown.

The method using the pre-mapped lookup table may be inadequate for an example needing a high-level sensibility In this case, the formerly described position-calculating method may be more adequate. Accordingly, the position calculating method can be adequately selected according to the design condition in accordance with the fields and environments to which the touch panel apparatus is applied.

Hitherto, the touch panel apparatus in accordance with an embodiment of the present invention has been described. The touch panel apparatus in accordance with an embodiment of the present invention can precisely recognize a contact position, a magnitude of a contact force, and a contact direction by using a simple structure only, in which a tactile sensor is disposed at a lower side of a typical flat panel, thereby reducing the overall size of the touch panel apparatus and the manufacturing cost.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. A touch panel apparatus, comprising:
a panel;
a plurality of tactile sensors, disposed at each corner of a lower surface of the panel; and
a position calculator, configured to calculate a two-dimensional coordinate corresponding to a contact position on the basis of a ratio of sensed values of a contact, outputted from the tactile sensors, if the contact is made on a surface of the panel.

2. The apparatus of claim 1, wherein:
the panel has a rectangular shape, and
each of the tactile sensors is disposed at each corner of a lower surface of the panel.

3. The apparatus of claim 1, wherein the position calculator calculates the coordinate corresponding to the contact position by converting the ratio of the sensed values to a geometric distance-proportional relationship on a two-dimensional coordinate.

4. The apparatus of claim 1, further comprising a table storage, configured to store a lookup table in which two-dimensional coordinates of the contact position are predetermined according to ratios of the sensed values,
wherein if the sensed values outputted from each of the tactile sensors are inputted, the position calculator calculates the coordinate corresponding to the contact position by computing the ratio of the inputted sensed values and extracting data mapped to the computed ratio from the lookup table.

5. The apparatus of claim 1, further comprising a magnitude calculator, configured to calculate a magnitude of a contact force generated at the contact position by comparing the sensed values with sensed values corresponding to a pre-standardized unit contact force.

6. The apparatus of claim 1, further comprising a direction calculator, configured to calculate a moving direction of the contact position on the basis of a continuous coordinate change, if a two-dimensional coordinate calculated by the position calculator is continuously changed while a contact is maintained on the surface of the panel.

7. The apparatus of claim 1, wherein the tactile sensor is a 3-axis force sensor which individually outputs sensed values in the x-, y-, and z-axis directions when a contact is made on the surface of the panel.

8. The apparatus of claim 1, wherein the tactile sensor is a pressure sensor which outputs a pressure-sensed value related to a pressure that is perpendicular to the surface of the panel on which the contact is made.

9. The apparatus of claim 1, wherein the panel is a display panel for displaying a video corresponding to an inputted video signal.
